(19) United States
(12) Patent Application Publication
(10) Pub. No.: US 2024/0195141 A1
(43) Pub. Date: Jun. 13, 2024

(54) SYSTEM FOR DETECTING PULSE DURATION FLUCTUATIONS OF LASER PULSES AND METHOD FOR GENERATING LASER PULSES

(71) Applicant: Active Fiber Systems GmbH, Jena (DE)

(72) Inventors: Tino EIDAM, Jena (DE); Steffen HÄDRICH, Weimar (DE); Fabian STUTZKI, Jena (DE)

(73) Assignee: Active Fiber Systems GmbH, Jena (DE)

(21) Appl. No.: 18/276,673

(22) PCT Filed: Feb. 9, 2022
(86) PCT No.: PCT/EP2022/053134

§ 371 Date: Feb. 19, 2024

(30) Foreign Application Priority Data
Feb. 11, 2021 (DE) 10 2021 103 204.0

(51) Int. Cl. H01S 3/13; H01S 3/00

(52) U.S. Cl. CPC H01S 3/1305; H01S 3/0057; H01S 3/0078; H01S 3/0092

(57) ABSTRACT

The disclosure provides an optical system which allows fluctuations in the pulse duration of ultrashort laser pulses to be detected quickly, sensitively and simply, and in a manner which makes it possible to derive an error signal for controlling the pulse duration from the detection. The optical system provided has a laser source (1) designed for generating pulsed laser radiation consisting of a chronological sequence of laser pulses, at least one dispersive optical element (4), designed to impress a group transit time dispersion and thus a chirp on the laser pulses, a nonlinear medium (5) designed for the non-linear spectral broadening of the laser pulses during propagation through the medium (5), and a detection device (6) designed to detect the spectral broadening. Furthermore, the disclosure relates to a method for generating laser pulses.

The invention relates to an optical system with a laser source that generates pulsed laser radiation consisting of a chronological sequence of laser pulses.

In addition, the invention relates to a method for generating laser pulses.

In particular, the invention relates to laser systems and methods for generating ultrashort laser pulses in the pico- and femtosecond range.

A variety of applications, especially scientific applications, require ultrashort laser pulses with highest performance and stability. Especially when the pulse peak power is an essential parameter for the application, the stability of the pulse duration is crucial in addition to the stability of the average power as well as the pulse-to-pulse energy stability.

Most high-power femtosecond laser systems make use of so-called chirped pulse amplification (CPA for short) (cf. D. Strickland, G. Mourou, “Compression of amplified chirped optical pulses,” Opt. Commun. 55(6), 447-449, 1985). In this process, to avoid interfering nonlinear effects and prevent material degradation in the amplification medium, the ultrashort laser pulses are temporally stretched before amplification by means of dispersive optical components, which lowers the peak pulse power and avoids the aforementioned interfering effects during the amplification process. After amplification, the time-stretched laser pulses are ideally compressed so that the resulting laser pulses are bandwidth-limited. This is again achieved by dispersive optical components with dispersion values largely reversed compared to the components used for stretching.

Fluctuations of the pulse shape and/or pulse duration can be caused e.g. by thermal effects in the components of the laser system. In particular, thermal effects in the dispersive components of the pulse stretching or pulse compression are typically the main cause of unwanted changes in the compressed pulse duration. It should be noted that the larger the stretching factor of the time stretched laser pulses and the larger the average power (and thus the ultimately never completely avoidable heat input in the optical components used for compression), the greater the negative influence of these thermal effects. Therefore, pulse duration fluctuations can be observed especially in CPA systems with high stretching factor and high average power.

An autocorrelator, for example, can be used to measure the pulse duration. This allows in principle to detect fluctuations of the pulse duration. Likewise, the dependence of nonlinear effects on the pulse peak power can be used to observe a deviation from an optimal pulse compression. Conceivable approaches for this are frequency conversion (e.g. second harmonic generation) or spectral broadening by self-phase modulation. However, the following problems arise with regard to the necessary correction: First, the sensitivity of the effects mentioned for the detection of pulse duration fluctuations is too low to detect the smallest, but ultimately decisive pulse duration fluctuations in applications. Secondly, the derivation of an error signal (control variable) necessary for the correction is not possible for the realization of a corresponding control, since an extension of the pulse duration starting from the point of optimum compression does not lead to any statement on the sign of the necessary correction of the dispersion values in the CPA system used.

In principle, known, more complex methods for the complete characterization of ultrashort laser pulses (such as FROG, SPIDER or D-scan methods) can be used to determine the phase terms to be compensated. However, this causes an unreasonably high effort for many applications and correspondingly high costs. Further problems are the speed of the measurement with such methods and the moderate sensitivity. Real-time correction of the pulse duration is thus hardly possible.

With this in mind, it is the task of the invention to provide an optical system that allows fluctuations in the pulse duration of ultrashort laser pulses to be detected quickly, sensitively, and simply, in a manner which makes it possible to derive an error signal for controlling the pulse duration from the detection.

This task is solved by the invention by means of an optical system with
a laser source designed to generate pulsed laser radiation consisting of a chronological sequence of laser pulses,
at least one dispersive optical element designed to impress a group transit time dispersion and thus a chirp on the laser pulses,
a nonlinear medium designed for nonlinear spectral broadening of the laser pulses during propagation through the medium,

and
a detection device adapted to detect the spectral broadening.

Furthermore, the invention solves the problem by a method for generating laser pulses, comprising the following method steps:
generating pulsed laser radiation consisting of a chronological sequence of laser pulses,
impressing a chirp on the laser pulses,
non-linear spectral broadening of the laser pulses, and
detection of the spectral broadening.

The approach of the invention is based on the spectral broadening of chirped laser pulses. The additional chirp impressed by the dispersive optical element affects the subsequent spectral broadening in the nonlinear medium in such a way that fluctuations in the pulse duration of the (ultrashort) laser pulses generated by the laser source can be sensitively detected on the basis of the spectral broadening, namely in a way that makes it possible to derive an unambiguous error signal for controlling the pulse duration from the detection. In this context, the impression of the additional chirp results in particular in the advantages that the smallest fluctuations of uncompensated dispersion in a CPA system have a significantly greater influence on the resulting pulse duration for the additionally chirped laser pulses than is the case for (nearly) bandwidth-limited laser pulses. Thus, the invention increases the sensitivity of the detection of pulse duration fluctuations.

Furthermore, due to the additionally imposed chirp, the change in spectral broadening in the nonlinear medium (e.g., due to self-phase modulation) depends on the sign of the fluctuation of the uncompensated dispersion in the CPA system. Consequently, an error signal can be derived directly to counteract the fluctuations occurring within the framework of a control system.

In a preferred embodiment, the dispersive optical element is designed to effect a pulse stretching of the laser pulses with an increase of the pulse duration by at least a factor of 1.1, preferably by at least a factor of 1.5, particularly preferably by at least a factor of 2.0. It has been shown that with these parameters the purpose intended by the invention can be reasonably achieved in practical applications.

The dispersive optical element for impressing the additional chirp may be formed by common optical components, such as an optical fiber, a grating array, a prism array, or one or more dispersive mirrors. Thus, the invention can be implemented with practical ease.

Expediently, the nonlinear medium is designed to effect spectral broadening by self-phase modulation. For this purpose, the nonlinear optical medium can be, for example, an optical fiber, a volume optical element, a gas-filled hollow core structure, or a multi-pass cell.

In a preferred embodiment, the detection device for detecting the spectral broadening comprises an optical spectrometer or at least one photosensor in combination with a spectral filter, in particular bandpass filters, edge filters or dispersive elements such as gratings and prisms with aperture, designed to select spectral components above or below the central wavelength, namely in a spectral range in which the laser radiation receives additional spectral intensity due to the nonlinear spectral broadening. In the latter way, by the simple use of a spectral filter and a photosensor (e.g. photodiode), the spectral width and thus indirectly the pulse duration change can be detected, in such a way that the detection signal is the analog output signal of the photosensor, which can be used directly as an error signal in the context of a control.

In a further preferred embodiment, a control device is provided which is connected to the detection device and the laser source, whereby the control device is designed to derive an actuating signal for controlling the laser source from the detected spectral broadening. In this context, the actuating signal expediently influences the pulse duration of the laser pulses. If, for example, the laser source comprises a CPA system, the actuating signal can be used to influence at least one dispersive optical component of the CPA system that causes stretching or compression of the laser pulses, i.e., the stretcher or the compressor, respectively. For example, the distance of a dispersive grating arrangement can be adjusted by controlling it with the actuating signal.

In one possible embodiment, the laser source is designed to generate substantially bandwidth-limited laser pulses. The invention can then be used to stabilize the pulse duration, for example, to improve quality in subsequent material processing or to improve the stability of downstream nonlinear pulse compression.

Examples of embodiments of the invention are explained in more detail below with reference to the drawings. Showing:

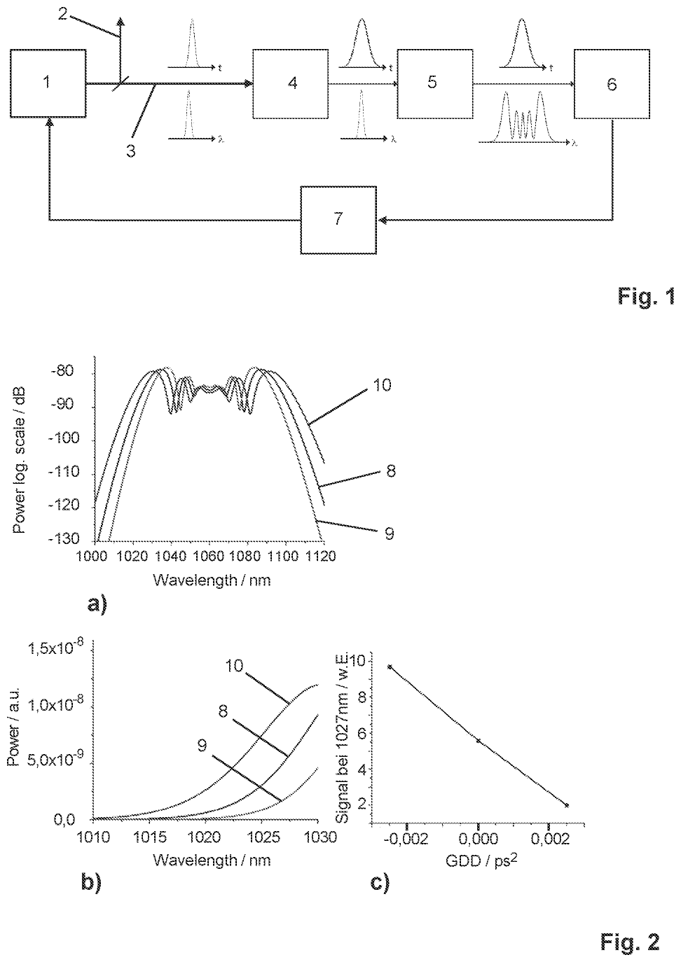

FIG. 1: Optical system according to the invention schematically as a block diagram;

FIG. 2: Illustration of the utilization of non-linear spectral broadening according to the invention;

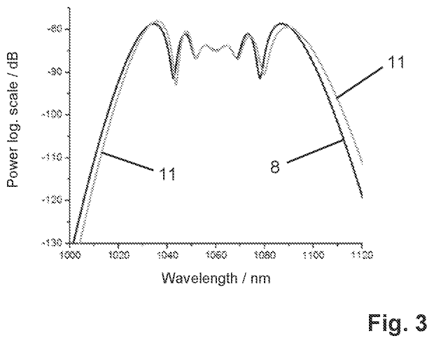

FIG. 3: Illustration of the influence of third-order dispersion on non-linear spectral broadening.

The optical system of FIG. 1 comprises a laser source 1, e.g. in the form of a CPA system of known design, which emits laser pulses with a pulse duration of 200 fs (FWHM, Gaussian-shaped laser pulses) at a central wavelength of 1060 nm. The actual useful beam 2 leaves the system and is used, for example, for material processing. A partial beam 3 is used for the detection of e.g. thermally caused fluctuations of the pulse duration according to the invention.

In FIG. 1, the pulse shape of the laser pulse and the spectrum of the laser pulse are shown above and below the beam path.

The laser pulses pass through a dispersive optical element 4 (e.g. an optical fiber with suitable dispersion), which impresses a group transit time dispersion and thus a chirp on the laser pulses. In this example, a group transit time dispersion of e.g. 0.025 ps² causes a temporal stretching of the laser pulses to approx. 400 fs.

Thereafter, the stretched laser pulses pass through a nonlinear medium 5 (e.g., an optical fiber with a suitable nonlinear refractive index), in which spectral broadening of the laser pulses occurs essentially by self-phase modulation. Assuming constant pulse energy, a change in the pulse duration of the laser pulses affects the spectral broadening by self-phase modulation quadratically, which provides an additional “lever” to increase the sensitivity in detecting pulse duration fluctuations in the CPA system of laser source 1. The spectrally broadened laser pulses are fed to a detection device 6. This generates at its output a signal dependent on the spectral broadening. This serves as an input signal, i.e. as a control variable or error signal, for a control device 7, which in turn is connected to the laser source 1. The control device 7 derives an actuating signal for controlling the laser source 1 from the output signal of the detection unit 6. The actuating signal influences the pulse duration of the laser pulses in that at least one dispersive optical component of the laser source 1 (e.g. CPA laser system) is influenced by the actuating signal. In this way, the pulse duration of the laser pulses in the useful beam 2 is stabilized.

The unambiguous derivation of the error signal is explained in more detail below with reference to FIG. 2. Hereby, the spectral broadening of the chirped laser pulses is considered. In this example, the following parameters apply: Pulse energy=1 μJ, non-linear refractive index=3.2·10⁻²⁰ m²/W, mode field diameter of the optical fiber used as nonlinear medium 5=20 μm, interaction length=1 cm, no dispersion during propagation through the nonlinear medium 5. The diagram of FIG. 2a shows the result of the spectral broadening after prior impression of the additional chirp, as explained above. Spectrum 8 shows the case without pulse duration fluctuation, i.e. the case where the CPA system of laser source 1 emits bandwidth-limited laser pulses. This is the target state of the control. An additional group transit time dispersion of +0.0025 ps² (corresponding to a pulse duration change from 200 fs to 203 fs in the nearly bandwidth-limited output beam) unintentionally impressed in the CPA system, e.g., due to thermal effects in the compressor, leads to a significant reduction of the spectral broadening, as can be seen from spectrum 9. The pulse duration behind the dispersive optical element 4 has increased in the example from 400 fs (in the case of bandwidth-limited laser pulses) to about 430 fs. In contrast, an unwanted group transit time dispersion in the laser source 1 of −0.0025 ps² leads to a significant amplification of the spectral broadening, as can be seen from the spectrum 10. In this case, the duration of the laser pulses at the input of the non-linear medium 5 has decreased from 400 fs to about 370 fs. A prerequisite for the clear influence of the mentioned, comparatively small dispersion fluctuations in the CPA system of the laser source 1 on the non-linear broadening, and thus on the sensitivity of the detection of the fluctuations, which can be seen in the diagram of FIG. 2a, is the impression of the additional chirp by means of the dispersive optical element 4. This is the essential insight which the invention makes use of.

To derive a sensitive and unambiguous error signal, the detection of the transmitted power by a spectral bandpass filter, e.g. at 1027 nm wavelength, i.e. outside the central wavelength of the laser pulses, is suitable in the example. The filter characteristic has to be adapted accordingly depending on the application. This is illustrated in FIGS. 2b and 2c. FIG. 2a shows the entire spectrum of the spectrally broadened laser pulses in a logarithmic diagram. FIG. 2b is a linear representation of the edges of the spectra 8, 9, 10 on the short wavelength side of the spectrum. FIG. 2c shows the output signal of a photodiode, which converts the intensity of the laser radiation at 1027 nm, i.e. after passing through the bandpass filter, into an electrical signal, as a function of the group transit time dispersion unintentionally impressed in the laser source 1. A negative unintentional group transit time dispersion leads to an increase and a positive unintentional group transit time dispersion leads to a decrease of the signal relative to a target value corresponding to the case of bandwidth-limited laser pulses. In the example shown, and assuming that the signal is a voltage in volts, the target point at 0.0 ps² (bandwidth-limited laser pulses) is 5.6 V and the response for deviations therefrom is −1.5 mV per fs². Thus, with appropriate low-noise detection of the photodiode signal, a sensitivity of about 10 fs² of unwanted group transit time dispersion around the target state of bandwidth-limited laser pulses is practically possible, corresponding to a fluctuation of only a few attoseconds at 200 fs pulse duration.

The signal measured in this way is used as an error signal for the control, as explained above with reference to FIG. 1. Conceivable is not only the adjustment of the grating spacing in a grating compressor of the CPA system based on this signal, but also the correction of the dispersion by a so-called Spatial-Light-Modulator (SLM) or a so-called Acousto-Optic Programmable Dispersive Filter (AOPDF/DAZZLER). Also conceivable, among other possibilities, are the use of temperature-controlled chirped fiber Bragg gratings as variable stretcher elements in the CPA system, a variable mini-compressor or an additional prism compressor.

The following should also be noted:
The target state of the control does not have to be the state of bandwidth-limited laser pulses. Likewise, it can be stabilized to a different, predefined pulse duration.
The additional chirp impressed according to the invention can also be negative. This only changes the sign of the error signal characteristic in FIG. 2c.
The sensitivity of the detection can be affected by the amount of nonlinear broadening, the additional chirp, and the choice of wavelength of the spectral filter before the photodiode.
Spectral broadening by self-phase modulation is only exemplary. Any non-linear effect that leads to spectral broadening dependent on pulse duration or pulse peak power can be used. Accordingly, different types of nonlinear media can be used for spectral broadening.
The detection of the pulse duration may be affected by fluctuations in the pulse energy (since e.g. a lower pulse energy also leads to a reduced broadening). This case of error can be factored out e.g. by measuring the total power/pulse energy simultaneously or by measuring at several spectral positions.

In practice, the mentioned thermally induced and unwanted pulse duration fluctuations will mostly be caused by effects that can be primarily described by second order dispersion. Nevertheless, it should be mentioned that the method of the invention also allows the distinction between second order dispersion and third order dispersion. Following the example described above in connection with FIG. 2, the diagram of FIG. 3 shows the effect of an additional unwanted third-order dispersion on the spectral broadening due to self-phase modulation under otherwise identical assumptions as shown above. Spectrum 8 again corresponds to the target condition of bandwidth-limited laser pulses. An unwanted and to be detected or compensated third order dispersion of 0.0005 ps³ leads to a clear and thus easily detectable asymmetry in the spectral broadening (spectrum 11) due to the asymmetry of the resulting temporal intensity profile of the laser pulse. By detecting the spectral power densities at the wings of the broadening (e.g. at 1027 nm and 1100 nm wavelength), this asymmetry can be detected and thus the relation between second and third order unwanted dispersion can be determined.

1. Optical system having
a laser source designed to generate pulsed laser radiation consisting of a chronological sequence of laser pulses,
at least one dispersive optical element designed to impress a group transit time dispersion and thus a chirp to the laser pulses,
a nonlinear medium designed for the non-linear spectral broadening of the laser pulses during propagation through the medium, and
a detection device designed to detect the spectral broadening.

2. Optical system according to claim 1, wherein the dispersive optical element is designed to effect pulse stretching of the laser pulses with increase of the pulse duration by at least a factor of 1.1, for example by at least a factor of 1.5, for example by at least a factor of 2.0.

3. Optical system according to claim 1, wherein the dispersive optical element is formed by an optical fiber, a grating array, a prism array, or one or more dispersive mirrors.

4. Optical system according to claim 1, wherein the non-linear medium is designed to effect spectral broadening by self-phase modulation.

5. Optical system according to of claim 1, wherein the non-linear optical medium is an optical fiber, a volume optical element, a gas-filled hollow core structure, or a multi-pass cell.

6. Optical system according to claim 1, wherein the detection device comprises:
an optical spectrometer or
at least one photosensor in combination with a spectral filter, for example bandpass filter, edge filter or dispersive element with aperture, designed to select spectral components above or below the central wavelength, namely in a spectral range in which the laser radiation receives additional spectral intensity due to the non-linear spectral broadening.

7. Optical system according to claim 1, further comprising a control device which is connected to the detection device and the laser source, wherein the control device is designed to derive an actuating signal for actuating the laser source from the detected spectral broadening.

8. Optical system according to claim 7, wherein the actuating signal influences the pulse duration of the laser pulses.

9. Optical system according to claim 1, wherein the laser source comprises a chirped pulse amplification system, wherein the actuating signal affects at least one dispersive optical component of the chirped pulse amplification system that causes stretching or compression of the laser pulses.

10. Optical system according to claim 1, wherein the laser source is adapted to generate substantially bandwidth-limited laser pulses.

11. Method for generating laser pulses, comprising the following method steps:
generating pulsed laser radiation consisting of a chronological sequence of laser pulses,
impressing a chirp on the laser pulses,
non-linear spectral broadening of the laser pulses, and
detection of the spectral broadening.

12. Method according to claim 11, wherein the pulse duration of the laser pulses is stabilized by deriving an actuating signal influencing the pulse duration from the detected spectral broadening.

13. Method according to claim 12, wherein the actuating signal affects a dispersive optical component of a laser source generating the pulsed laser radiation.
